(19) United States
(12) Patent Application Publication
(10) Pub. No.: US 2017/0227166 A1
(43) Pub. Date: Aug. 10, 2017

(54) Pistonless Subsea Pump

(71) Applicant: DRESSER-RAND COMPANY, Olean, NY (US)

(72) Inventors: William C. Maier, Almond, NY (US); Jose L. Gilarranz, Katy, TX (US)

(21) Appl. No.: 15/515,256

(22) PCT Filed: Oct. 12, 2015
(86) PCT No.: PCT/US2015/055099

§ 371 Date: Mar. 29, 2017

Related U.S. Application Data
(60) Provisional application No. 62/068,893, filed on Oct. 27, 2014.

(51) Int. Cl. F17D 1/00; F17D 3/01; F17D 1/14

(52) U.S. Cl. CPC F17D 1/005; F17D 1/14; F17D 3/01

(57) ABSTRACT

A method for boosting a multiphase fluid is provided. The method may include separating the multiphase fluid into a liquid phase and a gaseous phase in a separator, compressing the gaseous phase in a compressor, and discharging the compressed gaseous phase from the compressor to the discharge line. The method may also include draining the liquid phase from the separator to a liquid reservoir, passively actuating an inlet control valve to flow the liquid phase from the liquid reservoir to a liquid tank, and actively actuating an inlet actuation valve to flow a motive gas from the compressor to the liquid tank to thereby pressurize the liquid phase contained therein. The method may further include passively actuating an outlet control valve to discharge the pressurized liquid phase from the liquid tank to the discharge line, and combining the compressed gaseous phase with the pressurized liquid phase in the discharge line.

### BACKGROUND

This application claims priority to U.S. Provisional Patent Application having Ser. No. 62/068,893, which was filed Oct. 27, 2014. The aforementioned patent applications are hereby incorporated by reference in their entirety into the present application to the extent consistent with the present application.

Pumps and compressors may often be utilized to transport multiphase fluids (e.g., fluids containing liquids and gases) in a myriad of industrial processes (e.g., petroleum refineries and offshore oil production). For example, the pumps and compressors may often be utilized in a boosting station located proximal a production wellhead (e.g., subsea production wellhead) to boost or pressurize multiphase wellstream fluids and facilitate the transport of the wellstream fluids from the production wellhead to a remote location via pipelines (e.g., subsea pipelines). To transport the multiphase wellstream fluids, the gases and the liquids of the wellstream fluids may often be separated from one another and boosted in the compressors and the pumps, respectively. After boosting the gases and the liquids in the compressors and the pumps, the pressurized gases and liquids may be combined with one another in a single, multiphase pipeline downstream from the boosting station and transported to the remote location. In conventional boosting stations, the pumps utilized to pressurize the liquids are often mechanical pumps (e.g., centrifugal pumps, screw pumps, etc.) driven by electric motors. While the electrically driven mechanical pumps have proven to be effective in transporting the liquids, the utilization of the electrically driven mechanical pumps may often increase the complexity and decrease the reliability of the boosting stations.

In view of the foregoing, single, multiphase fluid pressure boosting devices, such as multiphase pumps, have been utilized. Utilizing the multiphase pumps in the boosting stations, however, may often be cost-prohibitive, as the multiphase pumps often exhibit decreased flow capacities and low reliability. Further, the cost associated with maintaining and servicing the multiphase pumps may often be exacerbated when the boosting stations are remotely located (e.g., subsea).

What is needed, then, is an improved fluid processing system and method for boosting a multiphase fluid in the fluid processing system.

### SUMMARY

Embodiments of the disclosure may provide a fluid processing system for boosting a multiphase fluid from a multiphase fluid source. The fluid processing system may include a separator, a compressor, and a pistonless pump assembly. The separator may be configured to separate the multiphase fluid from the multiphase fluid source into a substantially liquid phase and a substantially gaseous phase. The compressor may be fluidly coupled with the separator and configured to compress the substantially gaseous phase from the separator, and discharge the compressed substantially gaseous phase to a discharge line. The pistonless pump assembly may be configured to receive and pressurize the substantially liquid phase from the separator. The pistonless pump assembly may include a liquid reservoir fluidly coupled with the separator and configured to receive the substantially liquid phase from the separator, a first liquid tank fluidly coupled with the liquid reservoir, the compressor, and the discharge line, and a first conduit fluidly coupling the liquid reservoir and the first liquid tank. The pistonless pump assembly may also include a first inlet control valve, a first outlet control valve, and a first inlet actuation valve. The first inlet control valve may be coupled with the first conduit and configured to selectively control a flow of a first portion of the substantially liquid phase from the liquid reservoir to the first liquid tank. The first outlet control valve may be fluidly coupled with the first liquid tank and configured to control a flow of the first portion of the substantially liquid phase to the discharge line. The first inlet actuation valve may be coupled with the first liquid tank and configured to selectively control a flow of a first portion of a motive gas from the compressor to the first liquid tank.

Embodiments of the disclosure may also provide a method for boosting a multiphase fluid from a multiphase fluid source. The method may include separating the multiphase fluid from the multiphase fluid source into a substantially liquid phase and a substantially gaseous phase in a separator. The method may also include compressing the substantially gaseous phase in a compressor fluidly coupled with the separator, and discharging the compressed substantially gaseous phase from the compressor to a discharge line. The method may further include draining the substantially liquid phase from the separator to a liquid reservoir of a pistonless pump assembly. The method may also include passively actuating an inlet control valve to an opened position to flow the substantially liquid phase from the liquid reservoir to a liquid tank of the pistonless pump assembly. The method may also include actively actuating an inlet actuation valve to an opened position to flow a motive gas from the compressor to the liquid tank. The flow of the motive gas from the compressor to the liquid tank may increase a pressure in the liquid tank and pressurize the substantially liquid phase contained therein. The method may also include passively actuating an outlet control valve to an opened position to discharge the pressurized substantially liquid phase from the liquid tank to the discharge line. The method may further include combining the compressed substantially gaseous phase with the pressurized substantially liquid phase in the discharge line to thereby boost the multiphase fluid.

Embodiments of the disclosure may further provide another method for boosting a multiphase fluid from a multiphase fluid source. The method may include separating the multiphase fluid from the multiphase fluid source into a substantially liquid phase and a substantially gaseous phase in a separator. The method may also include compressing the substantially gaseous phase in a compressor fluidly coupled with the separator, and discharging the compressed substantially gaseous phase from the compressor to a discharge line. The method may further include draining the substantially liquid phase from the separator to a liquid reservoir of a pistonless pump assembly, and selectively operating a first liquid tank in an input mode or an output mode. Operating the first liquid tank in the input mode may include receiving a first portion of the substantially liquid phase from the liquid reservoir. Operating the first liquid tank in the output mode may include discharging the first portion of the substantially liquid phase from the first liquid tank to the discharge line. The method may also include selectively operating a second liquid tank in an input mode or an output mode. Operating the second liquid tank in the input mode may include receiving a second portion of the substantially liquid phase from the liquid reservoir. Operating the second liquid tank in the output mode may include discharging the second portion of the substantially liquid phase from the second liquid tank to the discharge line. The method may further include combining the compressed substantially gaseous phase with the first portion of the substantially liquid phase from the first liquid tank or the second portion of the substantially liquid phase from the second liquid tank to thereby boost the multiphase fluid.

### BRIEF DESCRIPTION OF THE DRAWINGS

The present disclosure is best understood from the following detailed description when read with the accompanying Figures. It is emphasized that, in accordance with the standard practice in the industry, various features are not drawn to scale. In fact, the dimensions of the various features may be arbitrarily increased or reduced for clarity of discussion.

FIG. 1 illustrates a schematic view of an exemplary fluid processing system, according to one or more embodiments disclosed.

FIG. 2A illustrates an elevated perspective view of an exemplary passive control valve that may be utilized in the fluid processing system of FIG. 1, according to one or more embodiments disclosed.

FIG. 2B illustrates a cross-sectional perspective view of the passive control valve of FIG. 2A, according to one or more embodiments disclosed.

FIG. 3A illustrates an elevated perspective view of another exemplary passive control valve that may be utilized in the fluid processing system of FIG. 1, according to one or more embodiments disclosed.

FIG. 3B illustrates a cross-sectional perspective view of the passive control valve of FIG. 3A, according to one or more embodiments disclosed.

FIG. 4 illustrates a flowchart of a method for boosting a multiphase fluid from a multiphase fluid source, according to one or more embodiments disclosed.

FIG. 5 illustrates a flowchart of another method for boosting a multiphase fluid from a multiphase fluid source, according to one or more embodiments disclosed.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Further, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

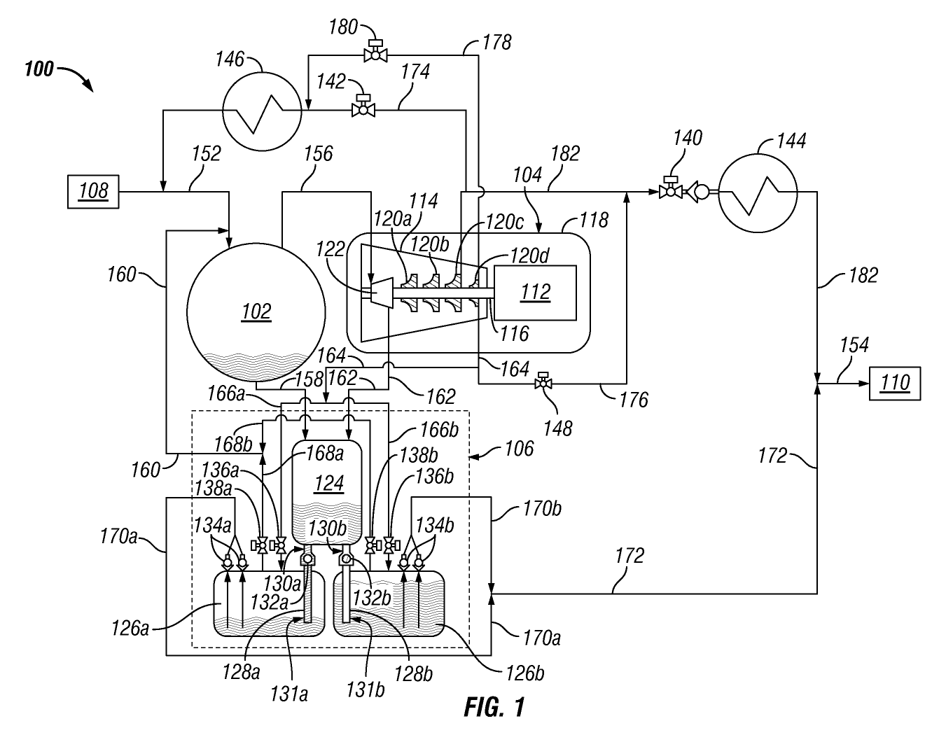

FIG. 1 illustrates a schematic view of an exemplary fluid processing system 100, according to one or more embodiments. The fluid processing system 100 may include a separator 102, a motor-compressor assembly 104, and a pistonless pump assembly 106 fluidly coupled with one another. The fluid processing system 100 may generally be configured to receive a multiphase fluid from a multiphase fluid source 108 via the inlet line 152, boost or pressurize the multiphase fluid and/or components thereof, and deliver the pressurized multiphase fluid to a downstream process 110 via the discharge line 154. The multiphase fluid source 108 may be or include, but is not limited to, a production field, a production well or wellhead (e.g., subsea or terrestrial production wellhead), a wellbore, a production pipeline, or the like. The multiphase fluid from the multiphase fluid source 108 may contain one or more hydrocarbons and/or one or more non-hydrocarbon fluids. Illustrative hydrocarbons may include, but are not limited to, methane, ethane, propane, butanes, pentanes, or the like, or any combination thereof. Illustrative non-hydrocarbons may include, but are not limited to, one or more aqueous solutions (e.g., water, salt water, etc.), air, inert gases (e.g., helium, nitrogen, carbon dioxide, etc.), or the like, or any combination thereof. Accordingly, it should be appreciated that the multiphase fluid may include at least one liquid phase and/or at least one vapor or gaseous phase.

The separator 102 may be fluidly coupled with the multiphase fluid source 108, the motor-compressor assembly 104, and/or the pistonless pump assembly 106. For example, as illustrated in FIG. 1, the separator 102 may be fluidly coupled with and disposed downstream from the multiphase fluid source 108 via the inlet line 152. As further illustrated in FIG. 1, the separator 102 may be fluidly coupled with and disposed upstream of the motor-compressor assembly 104 and the pistonless pump assembly 106 via line 156 and line 158, respectively. The separator 102 may also be fluidly coupled with and disposed downstream from the pistonless pump assembly 106 via line 160 and the inlet line 152. The separator 102 may be configured to receive the multiphase fluid from the multiphase fluid source 108 and at least partially or substantially separate the liquid phase and the gaseous phase contained in the multiphase fluid from one another. For example, at least a portion of the liquid phase of the multiphase fluid may settle or collect (e.g., via gravity) at a lower portion of the separator 102, and at least a portion of the gaseous phase of the multiphase fluid may collect at or migrate to an upper portion of the separator 102. As further described herein, the liquid phase collected in the lower portion of the separator 102 may be directed to the pistonless pump assembly 106 via line 158, and the gaseous phase collected in the upper portion of the separator 102 may be directed to the motor-compressor assembly 104 via line 156.

The motor-compressor assembly 104 may include a motor or driver 112 and a compressor 114 coupled with the driver 112 via a rotary shaft 116. The driver 112 and the compressor 114 may be disposed in a casing or housing 118 configured to hermetically seal the driver 112 and the compressor 114. The compressor 114 may include one or more stages (four are shown 120a-d) configured to compress or pressurize a process fluid (e.g., the gaseous phase). For example, as illustrated in FIG. 1, the compressor 114 may include a first stage 120a, one or more intermediate stages 120b, 120c, and/or a final stage 120d. As further illustrated in FIG. 1, the compressor 114 may be fluidly coupled with and disposed downstream from the separator 102 via line 156 and configured to receive a process fluid (e.g., the gaseous phase) therefrom. The compressor 114 may also be fluidly coupled with and disposed upstream of the pistonless pump assembly 106 via line 162 and line 164. The compressor 114 may further be fluidly coupled with and disposed upstream of the discharge line 154 via line 182 and line 176. For example, as illustrated in FIG. 1, an intermediate stage 120c of the compressor 114 may be fluidly coupled with and disposed upstream of the discharge line 154 via line 182, and the final stage 120d of the compressor 114 may be fluidly coupled with and disposed upstream of the discharge line via line 176. A valve 148 may be fluidly coupled with line 176 and configured to control the flow of the compressed gaseous phase from the last stage 120d of the compressor 114 to the discharge line 154.

In an exemplary embodiment, the compressor 114 may include a separation device 122 fluidly and/or operatively coupled with the stages 120a-d and/or the driver 112. For example, as illustrated in FIG. 1, the separation device 122 may be coupled with the stages 120a-d and the driver 112 via the rotary shaft 116. In another embodiment, the separation device 122 may be omitted from the compressor 114 or disposed outside the casing 118 of the compressor 114. The separation device 122 may be configured to at least partially separate and/or remove high-density components (e.g., the liquid phase) from low-density components (e.g., the gaseous phase) contained within a process fluid introduced thereto. The liquid phase separated from the gaseous phase may be discharged from the compressor 114 and directed to the pistonless pump assembly 106 via line 162. The gaseous phase from the separation device 122 may be directed to and through one or more of the stages 120a-d of the compressor 114. Illustrative separation device may include, but is not limited to, a rotating separator, a static separator, or the like.

The driver 112 may be coupled with and configured to drive the compressor 114 and/or one or more components thereof. For example, the driver 112 may be coupled with and configured to drive the separation device 122 and/or the stages 120a-d of the compressor 114 via the rotary shaft 116. Illustrative drivers may include, but are not limited to, electric motors, turbines, and/or any other device capable of driving the compressor 114 and/or the components (e.g., the separation device 122 and/or the stages 120a-d) thereof.

The pistonless pump assembly 106 may include one or more liquid reservoirs (one is shown 124) and one or more liquid tanks (two are shown 126a, 126b). The liquid reservoir 124 may be fluidly coupled with the liquid tanks 126a, 126b via one or more conduits (two are shown 128a, 128b). For example, the liquid reservoir 124 may be fluidly coupled with a first liquid tank 126a and a second liquid tank 126b via a first conduit 128a and a second conduit 128b, respectively. As illustrated in FIG. 1, respective first end portions 130a, 130b of the conduits 128a, 128b may be coupled with a lower portion of the liquid reservoir 124, and respective second end portions 131a, 131b of the conduits 128a, 128b may be disposed in the liquid tanks 126a, 126b. As further illustrated in FIG. 1, the first and second conduits 128a, 128b may extend into the first and second liquid tanks 126a, 126b such that the respective second end portions 131a, 131b of the conduits 128a, 128b may be disposed near or proximal respective lower portions of the first and second liquid tanks 126a, 126b. The conduits 128a, 128b may be or include, but are not limited to, an annular member, such as a pipe, a pipe section, a duct, or any other type of conduit capable of receiving, containing, and/or flowing a process fluid therethrough. The liquid reservoir 124 may be disposed above the first liquid tank 126a and the second liquid tank 126b such that the process fluid (e.g., the liquid phase) contained in the liquid reservoir 124 may flow or drain (e.g., via gravity) into the first and second liquid tanks 126a, 126b. For example, the process fluid contained in the liquid reservoir 124 may drain into the liquid tanks 126a, 126b without the aid of a pump.

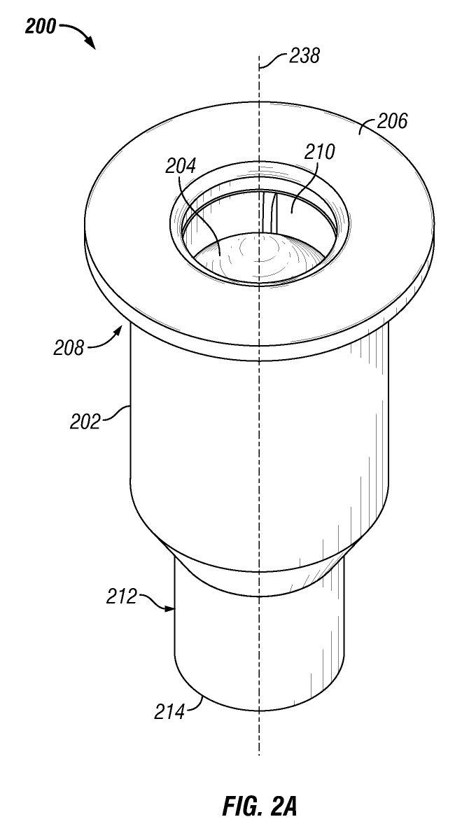

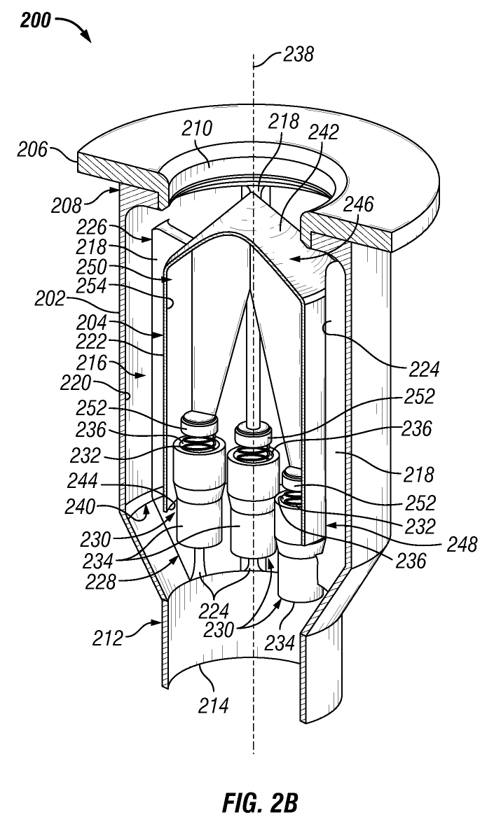

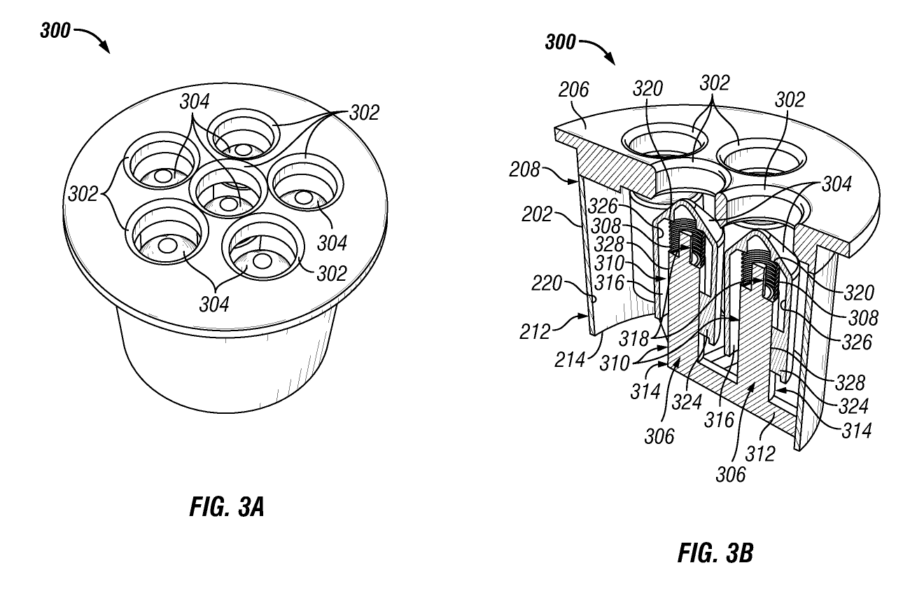

Fluid communication or flow of the process fluid from the liquid reservoir 124 to the first liquid tank 126a and/or the second liquid tank 126b via the first conduit 128a and/or the second conduit 128b, respectively, may be controlled by one or more inlet control valves (two are shown 132a, 132b). For example, as illustrated in FIG. 1, a first inlet control valve 132a and/or a second inlet control valve 132b may be coupled with the first conduit 128a and/or the second conduit 128b, respectively, and configured to selectively control the flow of the process fluid from the liquid reservoir 124 to the first liquid tank 126a and/or the second liquid tank 126b. The first and second inlet control valves 132a, 132b may be actuated together or separately. In at least one embodiment, the first and/or second inlet control valves 132a, 132b may be actuated actively. For example, the inlet control valves 132a, 132b may be actuated by a separate controller and/or actuation system (not shown). Illustrative actuation systems may include, but are not limited to, electrical actuators, pneumatic actuators, hydraulic actuators, or the like. In another embodiment, as further described herein with reference to FIGS. 2A, 2B, 3A, and 3B, the first and/or second inlet control valves 132a, 132b may be actuated passively (e.g., via a check valve). For example, the inlet control valves 132a, 132b may be actuated without a separate controller and/or actuation system.

The liquid reservoir 124, the first liquid tank 126a, and/or the second liquid tank 126b may each be or include any suitable device, vessel, container, or the like, capable of receiving, storing, and/or delivering the process fluid (e.g., the liquid phase). In an exemplary embodiment, the liquid reservoir 124, the first liquid tank 126a, and/or the second liquid tank 126b may be utilized in a subsea environment or application. It should be appreciated, however, that the liquid reservoir 124 and/or the first and second liquid tanks 126a, 126b may be equally utilized in land-based (e.g., terrestrial) applications. The liquid reservoir 124 and/or the first and second liquid tanks 126a, 126b may have any suitable shape and/or size (e.g., volumetric capacity). The shape and/or size of the liquid reservoir 124 may be determined, at least in part, by a respective size of the first conduit 128a and/or the second conduit 128b. The shape and/or size of the liquid reservoir 124 may also be determined, at least in part, by a respective size of the first liquid tank 126a and/or the second liquid tank 126b. For example, the liquid reservoir 124 may have a volumetric capacity greater than or substantially equal to about 25% of a volumetric capacity of the first liquid tank 126a and/or the second liquid tank 126b.

As previously discussed, the pistonless pump assembly 106 may be fluidly coupled with the separator 102 and/or the motor-compressor assembly 104. For example, the liquid reservoir 124 of the pistonless pump assembly 106 may be fluidly coupled with and disposed downstream from the separator 102 via line 158 and configured to receive a process fluid (e.g., the liquid phase) therefrom. The liquid reservoir 124 may also be fluidly coupled with and disposed downstream from the compressor 114 via line 162 and configured to receive a process fluid (e.g., the liquid phase) therefrom. For example, the liquid reservoir 124 may be fluidly coupled with and disposed downstream from the separation device 122 of the compressor 114 via line 162. The liquid reservoir 124 may also be disposed below the separator 102 and/or the compressor 114 of the motor-compressor assembly 104 such that the process fluid (e.g., the liquid phase) contained in the separator 102 and/or the compressor 114 may flow or drain (e.g., via gravity) into the liquid reservoir 124 via line 158 and line 162, respectively. In at least one embodiment, illustrated in FIG. 1, flow from the separator 102 and/or the compressor 114 to the liquid reservoir 124 via line 158 and/or line 162, respectively, may be unrestricted or unobstructed. For example, line 158 and/or line 162 may not include a flow control valve or any other device capable of regulating and/or restricting flow from the separator 102 and/or the compressor 114 to the liquid reservoir 124. In another embodiment, a flow control valve (not shown) may be coupled with lines 158 and/or 162 and configured to control a flow of the process fluid therethrough.

The first and second liquid tanks 126a, 126b may be fluidly coupled with and disposed upstream of the discharge line 154. For example, as illustrated in FIG. 1, the first liquid tank 126a may be fluidly coupled with and disposed upstream of the discharge line 154 via line 170a and line 172. In another example, the second liquid tank 126b may be fluidly coupled with and disposed upstream of the discharge line 154 via line 170b and line 172. As further described herein, each of the first and second liquid tanks 126a, 126b may be configured to discharge or direct a pressurized process fluid (e.g., a pressurized liquid phase) contained therein to the discharge line 154.

The flow of the pressurized process fluid from the first liquid tank 126a and/or the second liquid tank 126b to the discharge line 154 may be controlled by outlet control valves 134a, 134b. One or more outlet control valves 134a, 134b may be operatively coupled or associated with each of the first and second liquid tanks 126a, 126b. For example, the first liquid tank 126a may have at least two outlet control valves 134a operatively coupled therewith, and the second liquid tank 126b may have at least two outlet control valves 134b operatively coupled therewith. As illustrated in FIG. 1, the outlet control valves 134a may be coupled with line 170a and configured to selectively control the flow of the pressurized process fluid from the first liquid tank 126a to the discharge line 154. As further illustrated in FIG. 1, the outlet control valves 134b may be coupled with line 170b and configured to selectively control the flow of the pressurized process fluid from the second liquid tank 126b to the discharge line 154. The outlet control valves 134a, 134b may be actuated together or separately. In at least one embodiment, any one or more of the outlet control valves 134a, 134b may be actively actuated (e.g., with a separate controller and/or actuation system). In another embodiment, as further described herein, any one or more of the outlet control valves 134a, 134b may be passively actuated (e.g., automatically without a separate controller and/or actuation system).

The first and second liquid tanks 126a, 126b may be fluidly coupled with and disposed downstream from the compressor 114. For example, as illustrated in FIG. 1, the first liquid tank 126a may be fluidly coupled with and disposed downstream from the compressor 114 via line 164 and line 166a, and the second liquid tank 126b may be fluidly coupled with and disposed downstream from the compressor 114 via line 164 and line 166b. The first and second liquid tanks 126a, 126b may be fluidly and/or operatively coupled with any one or more of the stages 120a-d of the compressor 114. For example, as illustrated in FIG. 1, the first and second liquid tanks 126a, 126b may be fluidly coupled with the final stage 120d of the compressor 114. As further described herein, the first and second liquid tanks 126a, 126b may be configured to receive a pressurized process fluid (e.g., a motive gas and/or a compressed gaseous phase) from the compressor 114. One or more inlet actuation valves (two are shown 136a, 136b) may be disposed between the compressor 114 and the first and second liquid tanks 126a, 126b. For example, as illustrated in FIG. 1, a first inlet actuation valve 136a may be coupled with line 166a and configured to be modulated or actuated to control a flow of the pressurized process fluid from the compressor 114 to the first liquid tank 126a. In another example, a second inlet actuation valve 136b may be coupled with line 166b and configured to be modulated to control a flow of the pressurized process fluid from the compressor 114 to the second liquid tank 126b. In an exemplary embodiment, at least one of the inlet actuation valves 136a, 136b may be actively actuated.

The first and second liquid tanks 126a, 126b may be fluidly coupled with and disposed upstream of the separator 102. For example, as illustrated in FIG. 1, the first liquid tank 126a may be fluidly coupled with and disposed upstream of the separator 102 via line 160 and line 168a, and the second liquid tank 126b may be fluidly coupled with and disposed upstream of the separator 102 via line 160 and line 168b. As further described herein, the first and second liquid tanks 126a, 126b may be configured to discharge or vent the pressurized process fluid (e.g., a motive gas and/or a compressed gaseous phase) contained therein to the separator 102. One or more outlet actuation valves (two are shown 138a, 138b) may be disposed between the first and second liquid tanks 126a, 126b and the separator 102. For example, a first outlet actuation valve 138a may be coupled with line 168a and configured to be actuated to control a flow of the pressurized process fluid from the first liquid tank 126a to the separator 102. In another example, a second outlet actuation valve 138b may be coupled with line 168b and configured to be actuated to control a flow of the pressurized process fluid from the second liquid tank 126b to the separator 102. In an exemplary embodiment, at least one of the outlet actuation valves 138a, 138b may be actively actuated. It should be appreciated, however, that any one or more of the outlet actuation valves 138a, 138b may also be passively actuated.

In an exemplary operation of the fluid processing system 100, the separator 102 may receive the multiphase fluid from the multiphase fluid source 108 via the inlet line 152, and at least partially or substantially separate the liquid phase and the gaseous phase contained in the multiphase fluid from one another. The substantially separated liquid phase may settle or collect at the lower portion of the separator 102, and the substantially separated gaseous phase may collect at the upper portion of the separator 102. The substantially separated gaseous phase from the separator 102 may be directed to the motor-compressor assembly 104 via line 156. For example, the substantially separated gaseous phase may be directed from the separator 102 to the separation device 122 of the motor-compressor assembly 104. The separation device 122 may separate any remaining liquids or liquid phases from the substantially separated gaseous phase to thereby provide a substantially “dry” gaseous phase

The compressor 114 may compress the gaseous phase through at least one of the stages 120a-d thereof and direct the compressed gaseous phase to the discharge line 154. For example, as illustrated in FIG. 1, the compressor 114 may compress the gaseous phase through at least the first stage 120a and the intermediate stages 120b, 120c and direct the compressed gaseous phase to the discharge line 154 via line 182. At least a portion of the compressed gaseous phase from the intermediate stage 120c may be further compressed through the final stage 120d of the compressor 114 to provide a motive gas for the pistonless pump assembly 106. As illustrated in FIG. 1, a discharge valve 140 may be fluidly coupled with line 182 and configured to control the flow of the compressed gaseous phase from the motor-compressor assembly 104 to the discharge line 154. As further illustrated in FIG. 1, during one or more modes of operating the fluid processing system 100, at least a portion of the compressed gaseous phase flowing through line 182 may be directed to the inlet line 152 via line 174. A valve 142 may be fluidly coupled with line 174 and configured to control the flow of the compressed gaseous phase from line 182 to the inlet line 152. As illustrated in FIG. 1, at least a portion of the compressed gaseous phase from the final stage 120d of the compressor 114 may be directed to the inlet line 152 via line 178 and line 174. A valve 180 may be fluidly coupled with line 178 and configured to control the flow of the compressed gaseous phase from the final stage 120d to the inlet line 152.

The fluid processing system 100 may include one or more heat exchangers (two are shown 144, 146) disposed downstream from the compressor 114. For example, as illustrated in FIG. 1, a first heat exchanger 144 may be fluidly coupled with line 182 downstream from the compressor 114, and a second heat exchanger 146 may be fluidly coupled with line 174 downstream from the compressor 114. The first and second heat exchangers 144, 146 may be configured to cool or reduce a temperature of the compressed gaseous phase flowing therethrough. For example, compressing the gaseous phase in the compressor 114 may generate heat (e.g., the heat of compression), and the first and second heat exchangers 144, 146 may be configured to remove at least a portion of the heat to cool the compressed gaseous phase flowing therethrough. The first and second heat exchangers 144, 146 may be or include any device capable of reducing the temperature of the process fluid flowing therethrough. Illustrative heat exchangers may include, but are not limited to, a direct contact heat exchanger, a trim cooler, a mechanical refrigeration unit, or the like, or any combination thereof.

The separated liquid phases from the separator 102 and/or the separation device 122 may be directed (e.g., via gravity) to the liquid reservoir 124 of the pistonless pump assembly 106 via line 158 and/or line 162, respectively, and the liquid phase contained in the liquid reservoir 124 may be subsequently directed or flowed to the first liquid tank 126a and/or the second liquid tank 126b. The liquid reservoir 124 may be utilized or operated as a liquid capacitor in the fluid processing system 100. For example, as previously discussed, the flow of the liquid phase from the separator 102 and/or the separation device 122 to the liquid reservoir 124 may be unobstructed such that any portion of the liquid phase contained in the separator 102 and/or the separation device 122 may freely flow (e.g., via gravity) to the liquid reservoir 124. Accordingly, during one or more modes (e.g., transient modes) of operating the fluid processing system 100, when the first and/or second liquid tanks 126a, 126b may be unavailable, the fluid processing system 100 may continue to operate, as the liquid phase may freely flow to and be stored in the liquid reservoir 124. The liquid reservoir 124 may also allow the pistonless pump assembly 106 to operate using only one of the first and second liquid tanks 126a, 126b. For example, if one of the first and second liquid tanks 126a, 126b becomes disabled (e.g., component failure), the pistonless pump assembly 106 may continue to pump the liquid phase by utilizing any one or more of the remaining liquid tanks 126a, 126b.

The flow of the liquid phase from the liquid reservoir 124 to the first liquid tank 126a and/or the second liquid tank 126b may be determined by the mode in which the first liquid tank 126a and/or the second liquid tank 126b may be operating. For example, the first liquid tank 126a and the second liquid tank 126b may each be operated in one or more modes or regimes including, but not limited to, an input mode and an output or discharge mode. As further described herein, in the input mode, the respective liquid tank 126a, 126b may be in fluid communication with the liquid reservoir 124 via the respective inlet control valve 132a, 132b and configured to receive the liquid phase therefrom. Further, in the output mode, the respective liquid tank 126a, 126b may be in fluid communication with the discharge line 154 via the respective outlet control valve 134a, 134b and configured to discharge the liquid phase thereto. Accordingly, it should be appreciated that the actuation of the inlet control valves 132a, 132b and/or the outlet control valves 134a, 134b may at least partially determine the respective mode in which each of the first and second liquid tanks 126a, 126b may be operating.

As previously discussed, any one or more of the inlet control valves 132a, 132b or the outlet control valves 134a, 134b may be actuated passively. For example, any one or more of the inlet control 132a, 132b or the outlet control valves 134a, 134b may be actuated to an opened position when respective differential pressures across (e.g., between an inlet and an outlet) the control valves 132a, 132b, 134a, 134b exceed respective threshold or minimum differential pressures of the control valves 132a, 132b, 134a, 134b. The term “threshold differential pressure” may refer to a pressure differential between an inlet and an outlet of a valve sufficient to actuate the valve to an opened position. In an exemplary embodiment, the respective differential pressures across the inlet control valves 132a, 132b and/or the outlet control valves 134a, 134b may be determined, at least in part, by the inlet actuation valves 136a, 136b and/or the outlet actuation valves 138a, 138b. For example, the actuation or position (e.g., opened or closed) of the inlet actuation valves 136a, 136b and/or the outlet actuation valves 138a, 138b may be varied to increase or decrease the respective differential pressures across the inlet control valves 132a, 132b and/or the outlet control valves 134a, 134b. Accordingly, the actuation of the inlet control valves 132a, 132b and/or the outlet control valves 134a, 134b, and thus, the flow of the liquid phase to and/or from the first and second liquid tanks 126a, 126b, may be at least partially determined by the actuation of the inlet actuation valves 136a, 136b and/or the outlet actuation valves 138a, 138b.

FIG. 1 illustrates the first liquid tank 126a operating in the input mode, and the second liquid tank 126b operating in the output mode. While FIG. 1 illustrates the first liquid tank 126a and the second liquid tank 126b operating in the input mode and output mode, respectively, it should be appreciated that the first and second liquid tanks 126a, 126b may be operated in the same mode or different modes. For example, both the first and second liquid tanks 126a, 126b may be operating in the input mode or the output mode. In another example, only one of the first and second liquid tanks 126a, 126b may be operating in the input mode. It should further be appreciated that each of the first and second liquid tanks 126a, 126b and the respective valves coupled therewith (i.e., the inlet control valves 132a, 132b, the outlet control valves 134a, 134b, the inlet actuation valves 136a, 136b, and/or the outlet actuation valves 138a, 138b) may be similarly operated. Consequently, discussions herein regarding the operation of the first liquid tank 126a and the respective valves coupled therewith may be equally applicable to the second liquid tank 126b and the respective valves coupled therewith. Similarly, discussions regarding the operation of the second liquid tank 126b and the respective valves coupled therewith may be equally applicable to the first liquid tank 126a and the respective valves coupled therewith.

Referring to the first liquid tank 126a, in the input mode, the first liquid tank 126a may be prevented from being in fluid communication with the motor-compressor assembly 104 (e.g., high pressure section) of the fluid processing system 100. For example, the first inlet actuation valve 136a may be actuated to a closed position to thereby prevent fluid communication between the first liquid tank 126a and the motor-compressor assembly 104 (e.g., high pressure section) via lines 164 and 166a. Further, in the input mode, the first liquid tank 126a may be in fluid communication with the inlet line 152 and/or the separator 102. For example, the first outlet control valve 132a may be actuated to an opened position to thereby provide fluid communication between the first liquid tank 126a and the inlet line 152 via lines 168a and 160. In the input mode, the differential pressures across the outlet control valves 134a may be relatively less than the threshold differential pressures of the outlet control valves 134a. Accordingly, the outlet control valves 134a may be in a closed position, thereby preventing fluid communication between the first liquid tank 126a and the discharge line 154. Further, in the input mode, the differential pressure across the first inlet control valve 132a may be relatively greater than the threshold differential pressure of the first inlet control valve 132a, thereby actuating the first inlet control valve 132a to the opened position. Accordingly, in the input mode, the liquid phase contained in the liquid reservoir 124 may flow (e.g., via gravity) to the first liquid tank 126a via the first conduit 128a and the first inlet control valve 132a, and any gaseous phase contained in the first liquid tank 126a may vent to the inlet line 152 via the first outlet actuation valve 138a. The differential pressure across the first inlet control valve 132a may be determined, at least in part, by a weight of the liquid phase contained in the first conduit 128a above the first inlet control valve 132a. The differential pressure across the first inlet control valve 132 a may also be determined, at least in part, by a weight of the liquid phase contained in the liquid reservoir 124.

Referring to the second liquid tank 126b, in the output mode, the second outlet actuation valve 138b may be actuated to a closed position to prevent fluid communication between the second liquid tank 126b and the inlet line 152 via lines 168b and 160. Further, in the output mode, the second liquid tank 126b may be in fluid communication with the motor-compressor assembly 104 (e.g., the high pressure section) of the fluid processing system 100. For example, the second inlet actuation valve 136b may be actuated to an opened position to thereby provide fluid communication between the second liquid tank 126b and the compressor 114 via lines 164 and 166b. Fluid communication between the compressor 114 and the second liquid tank 126b may allow the flow of the motive gas and/or the compressed gaseous phase from the compressor 114 to the second liquid tank 126b. The flow of the compressed gaseous phase to the second liquid tank 126b may increase a pressure in the second liquid tank 126b. The increased pressure of the second liquid tank 126b may actuate the outlet control valves 134b to an opened position, and actuate the second inlet control valve 132b to a closed position. The increased pressure from the influx of the compressed gaseous phase from the compressor 114 to the second liquid tank 126b may also pressurized and/or drive the liquid phase contained in the second liquid tank 126b to the discharge line 154 via the outlet control valves 134b and lines 170a and 172. The liquid phase discharged from the second liquid tank 126b may be combined with the compressed gaseous phase from the compressor 114 in the discharge line 154 to thereby provide the boosted or pressurized multiphase fluid in the discharge line 154. The pressurized multiphase fluid contained in the discharge line 154 may be directed to the downstream process 110.

It should be appreciated that having at least two outlet control valves 134a, 134b associated or operatively coupled with each of the first and second liquid tanks 126a, 126b may increase the reliability and/or reduce maintenance of the pistonless pump assembly 106. For example, referring to the first liquid tank 126a and the outlet control valves 134a associated therewith, if one of the outlet control valves 134a becomes disabled or inoperable during the operation of the pistonless pump assembly 106, the remaining outlet control valve 134a may sufficiently control the flow or discharge of the pressurized process fluid from the first liquid tank 126a to the discharge line 154.

While FIG. 1 illustrates the last stage 120d of the compressor 114 fluidly coupled with the first and second liquid tanks 126a, 126b and configured to provide the compressed gaseous phase thereto via line 164, in at least one embodiment, the compressor 114 may not be fluidly coupled with the first and second liquid tanks 126a, 126b. In such an embodiment, the liquid phase contained in the first and second liquid tanks 126a, 126b may be driven to the discharge line 154 via a flow induced pressure drop. For example, the flow of the compressed gaseous phase from the compressor 114 to the discharge line 154 via the discharge valve 140, the first heat exchanger 144, and line 182 may induce a pressure drop between the discharge line 154 and the first and second liquid tanks 126a, 126b. The flow induced pressure drop between the discharge line 154 and the first and second liquid tanks 126a, 126b may actuate the respective outlet control valves 134a, 134b to the opened position and drive the liquid phase contained in the first and second liquid tanks 126a, 126b to the discharge line 154. In at least one embodiment, the fluid processing system 100 may include one or more throttling devices (not shown) fluidly coupled with line 172 and/or line 182 and configured to increase the flow induced pressure drop between the discharge line 154 the first and second liquid tanks 126a, 126b. Illustrative throttling devices may include, but are not limited to, throttle valves, fixed orifices, variable orifices, or the like, or any combination thereof.

The fluid processing system 100 may include a control system (not shown) operatively and/or communicably coupled with one or more components or assemblies thereof. The control system may include one or more sensors (e.g., pressure, weight, and/or liquid level sensors) operatively and/or communicably coupled with one or more components of the fluid processing system 100. For example, each of the first and second liquid tanks 126a, 126b may include a liquid level sensor (not shown) and/or a weight sensor (not shown) configured to determine an amount (e.g., volume, weight, etc.) of the liquid phase contained in each of the first and second liquid tanks 126a, 126b. The liquid level sensor and/or the weight sensor may also be configured to transmit signals (e.g., via wires or wirelessly) to the control system when the amount of the liquid phase contained in the first and/or the second liquid tanks 126a, 126b reaches a predetermined value. For example, the liquid level sensor and/or the weight sensor may transmit signals to the control system to indicate when the first and/or the second liquid tanks 126a, 126b may be partially full, substantially full, or substantially empty. The control system may receive the signals from the first and/or the second liquid tanks 126a, 126b and change the respective mode (e.g., input mode or output mode) in which each of the first and/or the second liquid tanks 126a, 126b may be operating. For example, if the first liquid tank 126a is substantially full, the control system may change the first liquid tank 126a from the input mode to the output mode. Conversely, if the first liquid tank 126a is substantially empty, the control system may change the first liquid tank 126a from the output mode to the input mode. The control system may be configured to operate the first and/or the second liquid tanks 126a, 126b between the input mode and the output mode by actuating the inlet actuation valves 136a, 136b and/or the outlet actuation valves 138a, 138b, as discussed above. For example, the control system may transmit signals to one or more actuation devices (not shown) operatively coupled with the inlet actuation valves 136a, 136b and/or the outlet actuation valves 138a, 138b to actuate the inlet actuation valves 136a, 136b and/or the outlet actuation valves 138a, 138b.

As previously discussed, the first and second conduits 128a, 128b may extend into the first and second liquid tanks 126a, 126b such that the respective second end portions 131a, 131b of the conduits 128a, 128b may be disposed near or proximal respective lower portions of the first and second liquid tanks 126a, 126b. The position of the respective second end portions 131a, 131b of the conduits 128a, 128b near or proximal the respective lower portions of the first and second liquid tanks 126a, 126b may facilitate the passive actuation of the inlet control valves 132a, 132b. In at least one embodiment, the position of the respective second end portions 131a, 131b of the conduits 128a, 128b near or proximal the respective lower portions of the first and second liquid tanks 126a, 126b may facilitate the passive actuation of the inlet control valves 132a, 132b to the closed position when the first liquid tank 126a and/or the second liquid tank 126b may be at least partially full of the liquid phase. For example, the liquid phase at the respective lower portions of the first and second liquid tanks 126a, 126b and/or contained in the respective second end portions 131a, 131b of the conduits 128a, 128b may exert a force on the inlet control valves 132a, 132b to passively actuate the inlet control valves 132a, 132b to the closed position. In another example, the liquid phase contained at the respective lower portions of the first and second liquid tanks 126a, 126b and/or the respective second end portions 131a, 131b of the conduits 128a, 128b may passively actuate the inlet control valves 132a, 132b to the closed position via buoyancy.

In at least one embodiment, the differential pressure across one or more of the inlet control valves 132a, 132b or the outlet control valves 134a, 134b may be sufficiently greater than the threshold differential pressure of a standard check valve. Accordingly, a standard check valve may be utilized for any one or more of the inlet control valves 132a, 132b and the outlet control valves 134a, 134b. In an exemplary embodiment, standard check valves may be utilized for both the first and second outlet control valves 134a, 134b, as the influx of the compressed gaseous phase (e.g., the motive gas) from the compressor 114 to each of the first and second liquid tanks 126a, 126b may sufficiently actuate the outlet control valves 134a, 134b to the opened position. Illustrative check valves may include, but are not limited to, spring return check valves or the like. In another embodiment, the differential pressure across one or more of the inlet control valves 132a, 132b or the outlet control valves 134a, 134b may be less than or substantially equal to the threshold differential pressure of the standard check valve. Accordingly, another passive control valve or valve system having a relatively lower threshold differential pressure than the standard check valve may be utilized for any one or more of the inlet control valves 132a, 132b and the outlet control valves 134a, 134b. In an exemplary embodiment, passive control valves having a threshold differential pressure relatively lower than the standard check valve may be utilized for both the first and second inlet control valves 132a, 132b, as the flow or influx of the liquid phase from the liquid reservoir 124 to each of the first and second liquid tanks 126a, 126b (e.g., via gravity) may not sufficiently actuate the inlet control valves 132a, 132b to the opened position.

FIGS. 2A and 2B illustrate an elevated perspective view and a cross-sectional perspective view, respectively, of an exemplary passive control valve 200 that may be utilized in the fluid processing system of FIG. 1, according to one or more embodiments. For example, the passive control valve 200 may be utilized for one or more of the inlet control valves 132a, 132b of the pistonless pump assembly 106 of FIG. 1. The passive control valve 200 may include an outer body or housing 202 and one or more inner bodies or plugs (one is shown 204) at least partially disposed within the housing 202. The housing 202 may be an annular member, such as a pipe, a pipe section, a duct, or any other type of conduit capable of receiving, containing, and/or flowing the process fluid (e.g., the liquid phase) therethrough. As illustrated in FIG. 2B, the housing 202 may include a disc or valve seat 206 coupled or integrally formed with a first axial end portion 208 thereof and defining a first opening or inlet 210 of the passive control valve 200. As further illustrated in FIG. 2B, a second axial end portion 212 of the housing 202 may define a second opening or outlet 214 of the passive control valve 200.

The passive control valve 200 and/or the housing 202 thereof may include a plug guide system 216 configured to facilitate the actuation of the plug 204 within the housing 202. For example, the plug guide system 216 may be configured to facilitate the actuation of the plug 204 by at least partially supporting and/or aligning the plug 204 within the housing 202. The plug guide system 216 may include one or more axial members or supports (three are shown 218) coupled or integrally formed with the housing 202. For example, as illustrated in FIG. 2B, the axial members 218 may be coupled with an inner circumferential surface 220 of the housing 202. The axial members 218 may at least partially extend from the inner circumferential surface 220 toward an outer circumferential surface 222 of the plug 204 to at least partially radially and/or axially align the plug 204 within the housing 202. In at least one embodiment, respective inner radial surfaces 224 of the axial members 218 may engage the outer circumferential surface 222 of the plug 204 to radially and/or axially align the plug 204 within the housing 202. In another embodiment, the respective inner radial surfaces 224 of the axial members 218 may be disposed radially outward of the outer circumferential surface 222 of the plug 204 to radially and/or axially align the plug 204 within the housing 202. The axial members 218 may extend substantially between the first and second axial end portions 208, 212 of the housing 202 to at least partially guide the actuation of the plug 204 within the housing 202. For example, as illustrated in FIG. 2B, respective first end portions 226 of the axial members 218 may be disposed near or proximal the first axial end portion 208 of the housing 202, and respective second end portions 228 of the axial members 218 may be disposed proximal the second axial end portion 212 of the housing 202. In an exemplary embodiment, illustrated in FIG. 2B, the passive control valve 200 may include three or more axial members 218 to guide the plug 204 within the housing 202.

The passive control valve 200 may also include one or more biasing assemblies (three are shown 230) configured to facilitate the actuation of the plug 204 within the housing 202. For example, the biasing assemblies 230 may be configured to apply or exert a biasing force or load to the plug 204 to actuate the plug 204 toward the first axial end portion 208 of the housing 202 and thereby actuated the passive control valve 200 to a closed position. As illustrated in FIG. 2B, each of the biasing assemblies 230 may include a biasing member, illustrated as a spring 232, configured to apply at least a portion of the biasing force or load to the plug 204, and a biasing support 234 configured to house or contain the spring 232. The respective biasing supports 234 of the biasing assemblies 230 may be coupled or integrally formed with any portion or component of the passive control valve 200. For example, each of the biasing supports 234 may be coupled with the respective second end portion 228 of each of the axial members 218. As illustrated in FIG. 2B, the respective second end portion 228 of each of the axial members 218 may at least partially extend radially inward to couple with each of the biasing supports 234. As further illustrated in FIG. 2B, each of the biasing supports 234 may at least partially define a blind hole or pocket 236. The respective spring 232 of each of the biasing assemblies 230 may be at least partially disposed in the blind hole 236, and may at least partially extend from the blind hole 236 to engage and apply a biasing force to the plug 204.

In at least one embodiment, a spring constant of each of the springs 232 may be varied to optimize the threshold differential pressure of the passive control valve 200. For example, the spring constant of each of the springs 232 may be increased or decreased to correspondingly increase or decrease the biasing force applied to the plug 204 and thereby increase or decrease the threshold differential pressure of the passive control valve 200. While the passive control valve 200 illustrated in FIG. 2B include three biasing assemblies 230, it should be appreciated that the passive control valve 200 may include any number of biasing assemblies 230. For example, the number of biasing assemblies 230 may be varied to optimize the threshold differential pressure of the passive control valve 200. For example, the number of the biasing assemblies 230 may be increased or decreased to correspondingly increase or decrease the biasing force applied to the plug 204 and the threshold differential pressure of the passive control valve 200.

The plug 204 of the passive control valve 200 may be or include an annular member configured to be at least partially disposed in the housing 202. As illustrated in FIG. 2B, the plug 204 may be disposed concentric with the housing 202 along a common axis 238 of the passive control valve 200. As further illustrated in FIG. 2B, the plug 204 and the housing 202 may at least partially define an annular volume or space 240 therebetween configured to provide fluid communication between the inlet 210 and the outlet 214 of the passive control valve 200. For example, the inner circumferential surface 220 of the housing 202 and the outer circumferential surface 222 of the plug 204 may at least partially define the annular space 240 therebetween.

In at least one embodiment, the plug 204 may have a closed axial end 242 and an open axial end 244. For example, as illustrated in FIG. 2B, a first axial end portion 246 of the plug 204 may define the closed axial end 242, and a second axial end portion 248 of the plug 204 may define the open axial end 244. In another embodiment, the plug 204 may have opposing closed axial ends (not shown) at the first and second axial end portions 246, 248 thereof. At least a portion of the plug 204 may be shaped to optimize the engagement between the plug 204 and the valve seat 206 and prevent fluid communication through the inlet 210 of the passive control valve 200. For example, as illustrated in FIG. 2B, at least a portion of the closed axial end 242 may be conical to optimize the engagement or sealing between the plug 204 and the valve seat 206 when the passive control valve may be in the closed position. In another example, at least a portion of the closed axial end 242 may be curved or arcuate to optimize the engagement or sealing between the plug 204 and the valve seat 206 when the passive control valve may be in the closed position.

The plug 204 may define an inner volume or cavity 250 at least partially extending between the first and second axial ends 246, 248 thereof. For example, as illustrated in FIG. 2B, the cavity 250 may at least partially extend from the open axial end 244 toward the closed axial end 242, and may be in fluid communication with the annular space 240, the inlet 210, and/or the outlet 214. As previously discussed, in an exemplary embodiment, the plug 204 may have opposing closed axial ends (not shown) at the first and second axial end portions 246, 248 thereof. It should appreciated that in an embodiment where the plug 204 may have opposing closed axial ends, the cavity 250 may not be in fluid communication with the annular space 240, the inlet 210, and/or the outlet 214 of the passive control valve 200. The cavity 250 may contain or be filled with a gas (e.g., the gaseous phase) to increase a buoyancy of the plug 204.

The plug 204 may be fabricated from one or more metals or metal alloys. For example, the plug 204 may be fabricated from thin metallic sheets of stainless steel. Other illustrative metals or metal alloys may include, but are not limited to, aluminum, an aluminum alloy, titanium, a titanium alloy, stainless steel, carbon steel, or the like, or any combination thereof. The plug 204 may also be fabricated from one or more polymeric materials. The polymeric materials may have a relatively lower density than the metals and/or metal alloys. The polymeric materials may have a relatively lower weight than the metals and/or metal alloys. Illustrative polymeric materials may include, but are not limited to, a thermoplastic material, such as poly(ether ether ketone) (PEEK), a non-conductive polymer, or the like. Fabricating the plug 204 from a polymeric material may increase the buoyancy of the plug 204. Increasing the buoyancy of the plug 204 may reduce the biasing force to actuate the plug 204 toward the first axial end portion 208 of the housing 202.

The plug 204 may have one or more spring supports (three are shown 252) configured to engage the biasing assemblies 230. The spring supports 252 may have any shape and/or size suitable for engaging the biasing assemblies 230. For example, as illustrated in FIG. 2B, each of the spring supports 252 may be cylindrical and configured to engage the respective spring 232 of each of the biasing assemblies 230. As further illustrated in FIG. 2B, the spring supports 252 may be coupled with an inner surface 254 of the plug 204. It should be appreciated that in an embodiment where the plug 204 may have opposing closed axial ends, one of the closed axial ends may engage the springs 232 of the biasing assemblies 230.

In an exemplary operation, the passive control valve 200 may be utilized for any one or more of the inlet control valves 132a, 132b of the pistonless pump assembly 106 of FIG. 1. For example, referring to FIGS. 2A and 2B with continued reference to FIG. 1, the passive control valve 200 may be used for the first inlet control valve 132a by coupling the passive control valve 200 with the first conduit 128a. The liquid phase contained in the liquid reservoir 124 may increase a pressure at the inlet 210 of the passive control valve 200, thereby increasing the differential pressure between the inlet 210 and the outlet 214 of the passive control valve 200. When the differential pressure across the passive control valve 200 exceeds the threshold differential pressure, the plug 204 may be actuated toward the outlet 214 to actuate the passive control valve 200 to an opened position and provide fluid communication from the liquid reservoir 124 to the first liquid tank 126a. As the liquid phase flows from the liquid reservoir 124 to the first liquid tank 126a, the pressure at the inlet 210 may correspondingly decrease, thereby decreasing the differential pressure across the passive control valve 200. When the differential pressure across the passive control valve 200 drops or falls below the threshold differential pressure, the plug 204 may be biased toward the valve seat 206 by the biasing assemblies 230 to thereby actuate the passive control valve 200 to the closed position. While discussions herein relate to utilizing the passive control valve 200 for the first inlet control valve 126a, it should be appreciated that the passive control valve 200 may be utilized for any one or more of the inlet control valves 132a, 132b and the outlet control valves 134a, 134b.

FIGS. 3A and 3B illustrate an elevated perspective view and a cross-sectional perspective view, respectively, of another exemplary passive control valve 300 that may be utilized in the fluid processing system 100 of FIG. 1, according to one or more embodiments. For example, the passive control valve 300 may be utilized for any one or more of the inlet control valves 132a, 132b of the pistonless pump assembly 106 of FIG. 1. The passive control valve 300 illustrated in FIGS. 3A and 3B may be similar in some respects to the passive control valve 200 described above and therefore may be best understood with reference to the description of FIGS. 2A and 2B, where like numerals may designate like components and will not be described again in detail. As illustrated in FIGS. 3A and 3B, the valve seat 206 may be coupled or integrally formed with the first axial end portion 208 of the housing 202, and may define one or more inlets (six are shown 302) of the passive control valve 300. The passive control valve 300 may include a plurality of plugs (six are shown 304) configured to engage the valve seat 206 to seal the respective inlets 302 extending therethrough.

As illustrated in FIG. 3B, the passive control valve 300 may include a plurality of biasing assemblies (two are shown 306) configured to facilitate the actuation of the plugs 304 within the housing 202. Each of the biasing assemblies 306 may include a biasing member, illustrated as a spring 308, configured to apply a biasing force or load to the respective plug 304, and a biasing support 310 configured to support the spring 308. The biasing supports 310 of the biasing assemblies 306 may be coupled or integrally formed with any portion of the housing 202. For example, as illustrated in FIG. 3B, the housing 202 may include a cross-member 312 extending radially inward from the inner circumferential surface 220 thereof, and a respective first end portion 314 of each of the biasing supports 310 may be coupled with the cross-member 312 of the housing 202. As illustrated in FIG. 3B, each of the biasing supports 310 may at least partially extend into a respective cavity 316 of each of the plugs 304. The spring 308 of each of the biasing assemblies 306 may be coupled with a respective second end portion 318 of each of the biasing supports 310. As illustrated in FIG. 3B, the springs 308 may extend from the second end portions 318 and engage respective inner axial end surfaces 320 of the plugs 304 to apply the biasing force thereto and actuate the plugs 304 toward the valve seat 206.

The passive control valve 300, similar to the passive control valve 200 of FIGS. 2A and 2B, may include a plug guide system configured to facilitate the actuation of the plugs 304 within the housing 202. The plug guide system may include one or more supports, illustrated as radially extending fins 324, coupled or integrally formed with each of the plugs 304. For example, as illustrated in FIG. 3B, a radially extending fin 324 may be integrally formed with a respective inner circumferential surface 326 of each of the plugs 304. Each of the radially extending fins 324 may extend from the respective inner circumferential surface 326 of each of the plugs 304 toward a respective outer circumferential surface 328 of each of the biasing supports 310 to radially and/or axially align the plugs 304 within the housing 202.

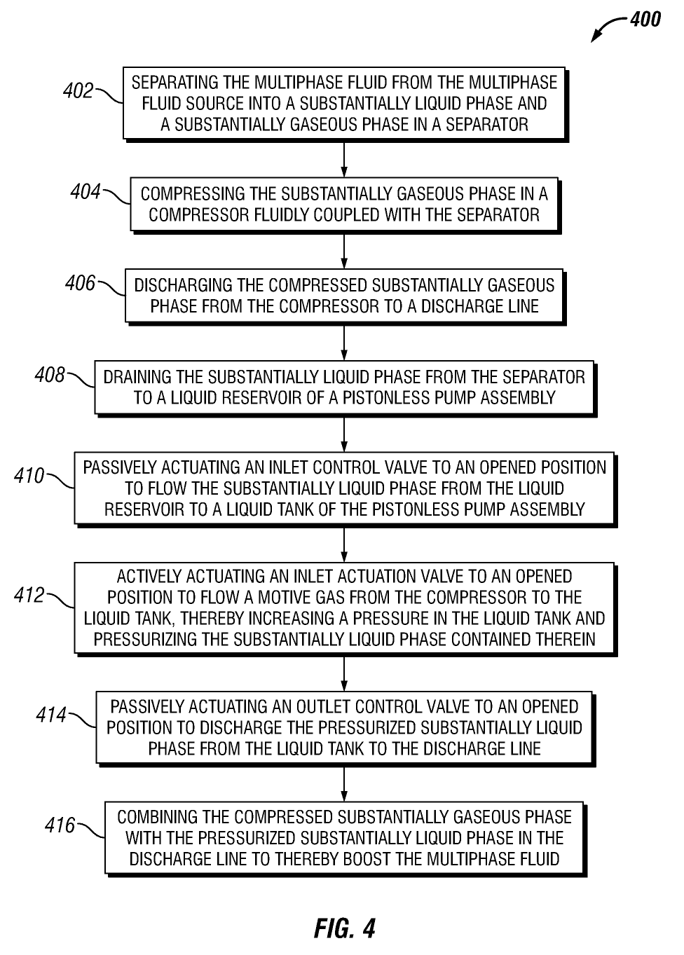

FIG. 4 illustrates a flowchart of a method 400 for boosting a multiphase fluid from a multiphase fluid source, according to one or more embodiments. The method 400 may include separating the multiphase fluid from the multiphase fluid source into a substantially liquid phase and a substantially gaseous phase in a separator, as shown at 402. The method 400 may also include compressing the substantially gaseous phase in a compressor fluidly coupled with the separator, as shown at 404. The method 400 may further include discharging the compressed substantially gaseous phase from the compressor to a discharge line, as shown at 406. The method 400 may also include draining the substantially liquid phase from the separator to a liquid reservoir of a pistonless pump assembly, as shown at 408. The method 400 may also include passively actuating an inlet control valve to an opened position to flow the substantially liquid phase from the liquid reservoir to a liquid tank of the pistonless pump assembly, as shown at 410. The method 400 may further include actively actuating an inlet actuation valve to an opened position to flow a motive gas from the compressor to the liquid tank, thereby increasing a pressure in the liquid tank and pressurizing the substantially liquid phase contained therein, as shown at 412. The method 400 may also include passively actuation an outlet control valve to an opened position to discharge the pressurized substantially liquid phase from the liquid tank to the discharge line, as shown at 414. The method 400 may further include combining the compressed substantially gaseous phase with the pressurized substantially liquid phase in the discharge line to thereby boost the multiphase fluid, as shown at 416.

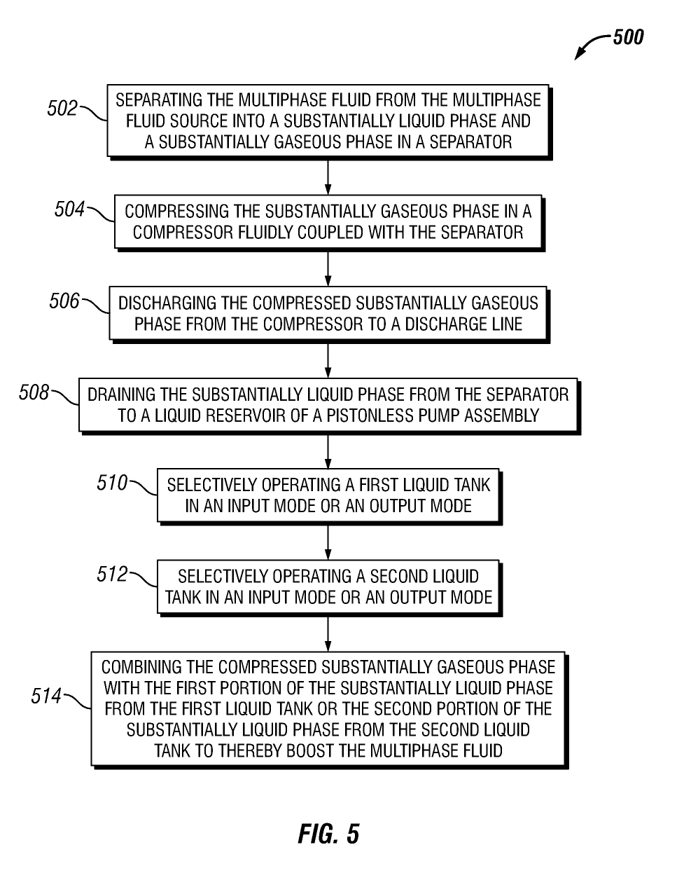

FIG. 5 illustrates another method 500 for boosting a multiphase fluid from a multiphase fluid source, according to one or more embodiments. The method 500 may include separating the multiphase fluid from the multiphase fluid source into a substantially liquid phase and a substantially gaseous phase in a separator, as shown at 502. The method 500 may also include compressing the substantially gaseous phase in a compressor fluidly coupled with the separator, as shown at 504. The method 500 may further include discharging the compressed substantially gaseous phase from the compressor to a discharge line, as shown at 506. The method 500 may also include draining the substantially liquid phase from the separator to a liquid reservoir of a pistonless pump assembly, as shown at 508. The method 500 may also include selectively operating a first liquid tank in an input mode or an output mode, as shown at 510. Selectively operating the first liquid tank in the input mode may include receiving a first portion of the substantially liquid phase from the liquid reservoir. Selectively operating the first liquid tank in the output mode may include discharging the first portion of the substantially liquid phase from the first liquid tank to the discharge line. The method 500 may further include selectively operating a second liquid tank in an input mode or an output mode, as shown at 512. Selectively operating the second liquid tank in the input mode may include receiving a second portion of the substantially liquid phase from the liquid reservoir, and selectively operating the second liquid tank in the output mode may include discharging the second portion of the substantially liquid phase from the second liquid tank to the discharge line. The method 500 may also include combining the compressed substantially gaseous phase with the first portion of the substantially liquid phase from the first liquid tank or the second portion of the substantially liquid phase from the second liquid tank to thereby boost the multiphase fluid, as shown at 514.

The foregoing has outlined features of several embodiments so that those skilled in the art may better understand the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

We claim:

1. A fluid processing system for boosting a multiphase fluid from a multiphase fluid source, comprising:
a separator configured to separate the multiphase fluid from the multiphase fluid source into a substantially liquid phase and a substantially gaseous phase;
a compressor fluidly coupled with the separator and configured to compress the substantially gaseous phase from the separator, and discharge the compressed substantially gaseous phase to a discharge line; and
a pistonless pump assembly configured to receive and pressurize the substantially liquid phase from the separator and comprising:
a liquid reservoir fluidly coupled with the separator and configured to receive the substantially liquid phase from the separator;
a first liquid tank fluidly coupled with the liquid reservoir, the compressor, and the discharge line;
a first conduit fluidly coupling the liquid reservoir and the first liquid tank;
a first inlet control valve coupled with the first conduit and configured to selectively control a flow of a first portion of the substantially liquid phase from the liquid reservoir to the first liquid tank;
a first outlet control valve coupled with the first liquid tank and configured to control a flow of the first portion of the substantially liquid phase to the discharge line; and
a first inlet actuation valve coupled with the first liquid tank and configured to selectively control a flow of a first portion of a motive gas from the compressor to the first liquid tank.

2. The fluid processing system of claim 1, wherein the first liquid tank is fluidly coupled with the separator and configured to vent the first portion of the motive gas to the separator.

3. The fluid processing system of claim 2, wherein the pistonless pump assembly further comprises a first outlet actuation valve coupled with the first liquid tank and configured to selectively control the venting of the first portion of the motive gas from the first liquid tank to the separator.

4. The fluid processing system of claim 1, wherein the compressor comprises a separation device fluidly coupled with the separator and the liquid reservoir, and configured to receive the substantially gaseous phase from the separator, separate at least a portion of a liquid phase from the substantially gaseous phase, and discharge the at least a portion of the liquid phase to the liquid reservoir.

5. The fluid processing system of claim 1, wherein the pistonless pump assembly further comprises:
a second liquid tank fluidly coupled with the liquid reservoir, the compressor, and the discharge line, and configured to receive a second portion of the substantially liquid phase from the liquid reservoir or a second portion of the motive gas from the compressor;
a second conduit fluidly coupling the liquid reservoir and the second liquid tank;
a second inlet control valve coupled with the second conduit and configured to selectively control a flow of the second portion of the substantially liquid phase from the liquid reservoir to the second liquid tank;
a second outlet control valve coupled with the second liquid tank and configured to control a flow of the second portion of the substantially liquid phase to the discharge line; and
a second inlet actuation valve coupled with the second liquid tank and configured to selectively control a flow of the second portion of the motive gas from the compressor to the second liquid tank.

6. The fluid processing system of claim 5, wherein the second liquid tank is fluidly coupled with the separator, and wherein the pistonless pump assembly further comprises a second outlet actuation valve coupled with the second liquid tank and configured to selectively control the venting of the second portion of the motive gas from the second liquid tank to the separator.

7. The fluid processing system of claim 1, further comprising one or more heat exchangers fluidly coupled with the compressor and configured to receive and cool the compressed substantially gaseous phase from the compressor.

8. The fluid processing system of claim 1, wherein the first inlet control valve and the first outlet control valve are passively actuated.

9. The fluid processing system of claim 1, wherein the first inlet control valve comprises:
an annular housing defining an inlet and an outlet at a first axial end portion and a second axial end portion thereof, respectively;
a plug slidably disposed within the annular housing;
a biasing assembly configured to apply a biasing force to the plug to slide the plug toward the inlet and thereby actuate the first inlet control valve to a closed position; and
a plug guide system configured to at least partially align the plug within the annular housing.

10. The fluid processing system of claim 9, wherein the plug comprises a polymeric material.

11. A method for boosting a multiphase fluid from a multiphase fluid source, comprising:
separating the multiphase fluid from the multiphase fluid source into a substantially liquid phase and a substantially gaseous phase in a separator;
compressing the substantially gaseous phase in a compressor fluidly coupled with the separator;
discharging the compressed substantially gaseous phase from the compressor to a discharge line;
draining the substantially liquid phase from the separator to a liquid reservoir of a pistonless pump assembly;
passively actuating an inlet control valve to an opened position to flow the substantially liquid phase from the liquid reservoir to a liquid tank of the pistonless pump assembly;
actively actuating an inlet actuation valve to an opened position to flow a motive gas from the compressor to the liquid tank, thereby increasing a pressure in the liquid tank and pressurizing the substantially liquid phase contained therein;
passively actuating an outlet control valve to an opened position to discharge the pressurized substantially liquid phase from the liquid tank to the discharge line; and
combining the compressed substantially gaseous phase with the pressurized substantially liquid phase in the discharge line to thereby boost the multiphase fluid.

12. The method of claim 11, further comprising:
actively actuating the inlet actuation valve to a closed position to prevent the flow of the motive gas from the compressor to the liquid tank; and
actively actuating an outlet actuation valve to an opened position to vent the motive gas from the liquid tank, thereby decreasing the pressure in the liquid tank.

13. The method of claim 11, wherein increasing the pressure in the liquid tank with the motive gas from the compressor passively actuates the inlet control valve to a closed position, thereby preventing the flow of the substantially liquid phase from the liquid reservoir to the liquid tank.

14. The method of claim 11, further comprising:
separating at least a portion of a liquid phase from the substantially gaseous phase in a separation device of the compressor; and
draining the at least a portion of the liquid phase from the separation device to the liquid reservoir.

15. A method for boosting a multiphase fluid from a multiphase fluid source, comprising:
separating the multiphase fluid from the multiphase fluid source into a substantially liquid phase and a substantially gaseous phase in a separator;
compressing the substantially gaseous phase in a compressor fluidly coupled with the separator;
discharging the compressed substantially gaseous phase from the compressor to a discharge line;
draining the substantially liquid phase from the separator to a liquid reservoir of a pistonless pump assembly;
selectively operating a first liquid tank in an input mode or an output mode, wherein:
operating the first liquid tank in the input mode comprises receiving a first portion of the substantially liquid phase from the liquid reservoir; and
operating the first liquid tank in the output mode comprises discharging the first portion of the substantially liquid phase from the first liquid tank to the discharge line;
selectively operating a second liquid tank in an input mode or an output mode, wherein:
operating the second liquid tank in the input mode comprises receiving a second portion of the substantially liquid phase from the liquid reservoir; and
operating the second liquid tank in the output mode comprises discharging the second portion of the substantially liquid phase from the second liquid tank to the discharge line; and
combining the compressed substantially gaseous phase with the first portion of the substantially liquid phase from the first liquid tank or the second portion of the substantially liquid phase from the second liquid tank to thereby boost the multiphase fluid.

16. The method of claim 15, wherein the first liquid tank is operating in the input mode and the second liquid tank is operating in the output mode.

17. The method of claim 15, wherein operating the first liquid tank in the input mode further comprises:
venting the first liquid tank to decrease a pressure in the first liquid tank by actively actuating an outlet actuation valve to an opened position; and
passively actuating an inlet control valve to an opened position to thereby provide fluid communication between the liquid reservoir and the first liquid tank.

18. The method of claim 17, wherein venting the first liquid tank to decrease the pressure in the first liquid tank comprises venting a motive gas from the first liquid tank to the separator.

19. The method of claim 15, wherein operating the first liquid tank in the output mode further comprises:
pressurizing the first liquid tank to increase a pressure in the first liquid tank by actively actuating an inlet actuation valve to an opened position; and
passively actuating an outlet control valve to an opened position to thereby provide fluid communication between the first liquid tank and the discharge line.

20. The method of claim 15, further comprising:
separating at least a portion of a liquid phase from the substantially gaseous phase in a separation device of the compressor; and
draining the at least a portion of the liquid phase from the separation device to the liquid reservoir.
